(19) United States
(12) Patent Application Publication
(10) Pub. No.: US 2021/0198480 A1
(43) Pub. Date: Jul. 1, 2021

(54) FLAME RETARDANT COMPOSITION AND INSULATED WIRES FOR USE IN ELECTRONIC EQUIPMENT

(71) Applicant: DSM IP Assets B.V., Heerlen (NL)

(72) Inventor: Carel Frederik Constantijn FITIÉ, Echt (NL)

(21) Appl. No.: 16/650,605

(22) PCT Filed: Sep. 25, 2018
(86) PCT No.: PCT/EP2018/075978

§ 371 Date: Mar. 25, 2020

(30) Foreign Application Priority Data
Sep. 29, 2017 (EP) 17194266.7

(51) Int. Cl. C08L 67/08; C09K 21/12; H01B 7/295; H01B 7/00; H01B 3/42

(52) U.S. Cl. CPC C08L 67/08; C09K 21/12; C08L 2201/02; H01B 7/0009; H01B 3/421; H01B 7/295

(57) ABSTRACT

This invention relates to a flame retardant composition comprising Component (A) being a thermoplastic copolyester elastomer comprising 20 to 80 wt. % of monomeric units derived from a dimerised fatty acid or a derivative thereof and further monomeric units derived of at least one dicarboxylic acid and at least one diol, wherein wt % is with respect to the total weight of the thermoplastic copolyester elastomer; and Component (B) being a metal salt of a phosphinic acid of the formula [R¹R²P(O)O]-ₘM^{m+} (formula I) and/or a diphosphinic acid of the formula [O(O)PR¹—R³—PR²(O)O]²-ₙMₓ^{m+} (formula II), and/or a polymer thereof, wherein —R¹ and R² are equal or different substituents chosen from the group consisting of hydrogen, linear, branched and cyclic C1-C6 aliphatic groups, and aromatic groups, —R³ is chosen from the group consisting of linear, branched and cyclic C1-C10 aliphatic groups and C6-C10 Caromatic and aliphatic-aromatic groups, —M is a metal chosen from the group consisting of Mg, Ca, Al, Sb, Sn, Ge, Ti, Zn, Fe, Zr, Ce, Bi, Sr, Mn, Li, Na, and K, and —m, n and x are equal or different integers in the range of 1-4; as well as an insulated wire for use in electronic equipment, comprising an electrically conductive core and an insulating layer and/or an insulating jacket comprising or consisting of the flame retardant composition.

The present invention relates to a flame retardant composition for use in insulated wires for use in electronic equipment, comprising an electrically conductive core and an insulating layer surrounding the electrically conductive core. More particularly, the present invention relates to insulated wires for electronic equipment having excellent consumer appeal (flexible, light, soft and smooth), mechanical and electrical characteristics, humidity, heat and UV resistance and flame retardancy.

Insulated wires, cables, and cords, which are used for inner and outer wiring of electric/electronic equipment and the like, are required to have various characteristics, including flame retardancy, heat resistance, electrical and mechanical characteristics (e.g. tensile properties and abrasion resistance). The standards, for example, of the flame retardancy, the heat resistance, and the mechanical characteristics (e.g. tensile properties and abrasion resistance) required for wiring materials of electric/electronic equipment are stipulated in UL, JIS, etc. in particular, with respect to the flame retardancy, its test method varies depending on the required level (its use to be applied) and the like. Therefore, practically, it is enough for the material to have at least the flame retardancy according to the required level. For example, mention can be made the respective flame-retardancy to pass the vertical flame test (VW-1) stipulated in UL 1581 (Reference Standard for Electrical wires, Cables, and Flexible Cords), or the horizontal test and the inclined test stipulated in JIS C 3005 (rubber/plastic insulated wire test method). Further, wiring materials used in electric/electronic equipment are sometimes required to have a heat resistance of 80° C. to 105° C., or even 125° C., while in continuous use.

Halogen free compounds comprising polyolefin copolymers and a halogen free flame retardant system comprising metal hydrate and optionally red phosphorous, were used as the wiring insulating material. Red phosphorous was used to enable reduction of the metal hydrate, since the metal hydrate, when used alone, had to be added in such high amounts that mechanical properties were jeopardized. However, flame retardant materials containing phosphorus pose problems in that when the material is burned the phosphorus can produce toxic fumes whereas when the material is discarded the phosphorus can pollute the water environment by eutrophication. Furthermore, where wires and cables have to be coded with colour codes, red phosphorus cannot be used. To comply with the heat resistance requirements, the covering material is crosslinked by an electron beam crosslinking method or a chemical crosslinking method, in order to render the wiring material highly heat resistant or an isolating material comprising a high melting point, such as a high melting polypropylene is used. Crosslinking however prevents melting of the insulating material and thus limits recyclability whereas the measures for crosslinking, either chemically by use of special additives or with special equipment, such as an electron beam crosslinking equipment, increases the cost of the electrical wire. On the other hand, where a high proportion of resin such as a polypropylene, is used the flexibility is poor, and when the wiring material covered with such a resin is bent, a phenomenon occurs that whitens the surface.

Thermoplastic polymer compositions comprising styrenic block copolymers, olefinic thermoplastic elastomers and combinations thereof, a flame retardant and copolyester elastomers were disclosed in WO09047353 to combine sufficient mechanical, and flame retardant properties in wire applications. However, there is still a need to improve the flame retardant properties, or alternatively, decrease the content of flame retardants while maintaining similar flame retardant properties.

A thermoplastic polymer composition for the purposes of the present invention means a polymer composition which is or has the ability to be repeatedly heat processable, such that the material is considered to be recyclable in the same or other applications. Thus, the mechanical properties of a thermoplastic plastic composition which has been processed once or several times into the insulating covering of a wire or the like are comparable with the properties of the starting material.

A thermosetting composition for the purposes of the present invention means a polymer composition which is or has the ability to be crosslinked to the extent that is no longer repeatedly heat processable, such that the material is not considered recyclable. Typically this is achieved through electron beam crosslinking method or a chemical crosslinking method.

A covering material of an electrical wire used for consumer electronic appliances is also required to satisfy dynamic properties stipulated, e.g., under UL Standard, more specifically for thermoplastic elastomer based materials, required to have an elongation of at least 200% and a tensile strength of at least 8.3 MPa for an outer insulated jacket and at least 5.5 MPa for an inner insulating layer. In particular, a covering material of electrical or data cables is required to further have a good flexibility because these cables are shipped in the bundled state.

In certain applications, the insulated wires are also required to have good electrical properties, such as arc tracking resistance (class 1 (>400V) or class 0 (>600V)) as measured through the comparative tracking index (CTI). This property is especially important when the insulated wire is operated within an electrical field.

In addition to these flame retardant, electrical and mechanical functional properties, there is increasing demand for insulated wires which have consumer appeal. The increasing popularity of electronic equipment such as computers, music and multi-media devices has led to heavy competition and, as such, a need for manufacturers to differentiate their product in the market. Embodiments of insulated wires include headphone wiring, power cables and a myriad of cabling which interconnect various components of multi-media technology (eg. USB cables). While wireless technology has been developed in an attempt to free the consumer from an entanglement of wires, there will still be a need for insulated wires. In these instances, insulated wires with increased consumer appeal will be sought after. Insulated wires which are light (low density), soft, easily bendable, glossy and/or smooth are thought to be attributes which induce consumer appeal. The abovementioned mechanical attributes solve the problem of wires which get tangled; caught up on foreign objects; create excessive friction when passing over surfaces; causing skin irritation and/or consumer discomfort when constantly contacted; and so on. The solving of these problems creates consumer appeal. The functional demands placed upon insulated wires to conform to flame retardant, mechanical and electrical properties make the further limitation of “consumer appeal” a challenging task.

Improvements in the halogen free flame retardant compositions for moulded articles including electrical and electronic components are disclosed in WO 2005/118698 which provides a solution that includes a polyamide, an aromatic polymer and a flame retardant system comprising a metal phosphinate or diphosphinate salt; and at least one nitrogen compound derivable from the condensation products of melamine and/or reaction products of condensation products of phosphoric acid. The document discloses that additional layers of coatings may be applied to the substrate to impart additional properties, such as scratch resistance and aesthetic appeal. The resulting composition was shown to have improved electrical and flammability properties.

The problems associated with increasing the consumer appeal of insulated wires, while maintaining sufficient mechanical, electrical and flame retardant properties, has been addressed, in part, by the use of flame retardants in combination with thermoplastic elastomers which exhibit the properties of softness, flexibility and resilience. However there is need for further improvements in flame retardant compositions and insulated wires comprising this composition, particularly those directed towards the consumer market.

Surprisingly, this need has been met by a flame retardant composition comprising
Component (A) being a thermoplastic copolyester elastomer comprising 20 to 80 wt. % of monomeric units derived from a dimerised fatty acid or a derivative thereof and further monomeric units derived of at least one dicarboxylic acid and at least one diol, wherein wt % is with respect to the total weight of the thermoplastic copolyester elastomer; and
Component (B) being a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
   R¹ and R² are equal or different substituents chosen from the group consisting of hydrogen, linear, branched and cyclic C1-C6 aliphatic groups, and aromatic groups,
   R³ is chosen from the group consisting of linear, branched and cyclic C1-C10 aliphatic groups and C6-C10 aromatic and aliphatic-aromatic groups,
   M is a metal chosen from the group consisting of Mg, Ca, Al, Sb, Sn, Ge, Ti, Zn, Fe, Zr, Ce, Bi, Sr, Mn, Li, Na, and K, and
   m, n and x are equal or different integers in the range of 1-4.

Inventors have found, when employing component (A), that the flame retardant properties improve when using the same amount of flame retardants, which has been exemplified by examples. Alternatively, the amount of flame retardant can be decreased, while retaining sufficient flame retardant properties, which is beneficial as this increases softness, provides better processability, higher overall consumer appeal and lower ecological footprint of the materials.

The aim of the invention is also to provide insulated wires for use in electronic equipment comprising an electrically conductive core and an insulating layer surrounding the electrically conductive core consisting of a flame retardant composition, which provide a good balance between flame retardancy, mechanical and electrical properties. Moreover, the insulated wires must also have good consumer appeal, as provided by a combination of good softness, surface smoothness, low density and/or flexibility.

In another embodiment of the present invention there is provided an insulated wire for use in electronic equipment, comprising an electrically conductive core and an insulating layer and/or an insulating jacket consisting of a flame retardant composition surrounding the electrically conductive core, wherein the flame retardant composition comprises
Component (A) being a thermoplastic copolyester elastomer comprising 20 to 80 wt. % of monomeric units derived from a dimerised fatty acid or a derivative thereof and further monomeric units derived from at least one dicarboxylic acid and at least one diol, wherein wt % is with respect to the total weight of the thermoplastic copolyester elastomer; and
Component (B) being a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
   R¹ and R² are equal or different substituents chosen from the group consisting of hydrogen, linear, branched and cyclic C1-C6 aliphatic groups, and aromatic groups,
   R³ is chosen from the group consisting of linear, branched and cyclic C1-C10 aliphatic groups and C6-C10 aromatic and aliphatic-aromatic groups,
   M is a metal chosen from the group consisting of Mg, Ca, Al, Sb, Sn, Ge, Ti, Zn, Fe, Zr, Ce, Bi, Sr, Mn, Li, Na, and K, and
   m, n and x are equal or different integers in the range of 1-4; and
Optionally a component (C) being a styrenic block copolymer and/or an olefinic thermoplastic elastomer.

Component (A) is present in the composition to impart improved mechanical and thermal stability properties. In this aspect of the present invention, the compositions possess good heat deformation properties that allow the compositions to be exposed to elevated temperatures without excessive permanent deformation. This property is particularly important as it enables the cables to maintain their shape and flexibility while being exposed to elevated temperatures encountered in everyday situations, such as contact with hot beverages or electrical appliances. The electrical risk associated with a reduced insulating layer due to poor heat deformation properties is also reduced.

It has been unexpectedly found that the flame retardant properties of insulated wires may be enhanced through the flame retardant composition of the present invention, thus offering a better balance between consumer appeal and the required flame retardant, electrical and/or mechanical properties. The final effect of the insulating layer and/or jacket in the insulated wire according to the present invention comprising or even consisting of the flame retardant composition is that the insulated wire has flame retardancy properties compliant with UL 1581 VW-1 and exhibits mechanical properties which are both functional and attractive to the consumer, such as softness, high flexibility, low heat deformation and/or smooth surface properties.

In certain embodiments, the flame retardant composition may further comprise a component (D) being a nitrogen containing flame retardant synergist and/or a phosphor/nitrogen containing flame retardant and/or a component (E) being basic and amphoteric oxides, hydroxides, carbonates, silicates, borates, stannates, mixed oxide-hydroxides, oxide-hydroxide-carbonates, hydroxide-silicates and hydroxide-borates, and mixtures thereof.

Components (D) and (E) provide additional flame retardant properties and may be advantageously combined with component (B) to provide a cost-effective flame retardant system.

The flame retardant composition may consist essentially of the combination of the polymer component (A) with flame retardant components (B) and (D) has the advantage that it may be able to satisfy the flame retardant requirements of the UL 1581 VW-1 standard. The presence of further thermoplastic polymer components, referred below to as component (G), may further enhance the electrical, mechanical and/or consumer appeal properties.

Flame retardant properties compliant with the UL 1581 VW-1 standard are obtainable for an insulated wire according to the present invention when the flame retardant components (B) and (D) are present in a lower amount, i.e. at lower levels than for a comparable composition comprising a copolyester elastomer with an ether based soft segments instead of component (A). This result is highly surprising in particular in view of the fact that the intrinsic flame retardant properties of various organic soft components are generally poor and highly comparable.

The specific flame retardant composition may be adjusted to be suitable for use as insulting layer or jacket in electrical cables which are required to have flame retarding properties complying with UL 1581 VW-1.

In preferred embodiments of the invention, the insulated wires also have a class 0 or class 1 rating under the CTI.

The relative lower levels of flame retardants, as defined in the present invention, required to achieve the flame retardant objectives of a specific insulated wire end-use applications combined with the advantageous properties of the styrenic block copolymer or olefinic thermoplastic elastomers, enable a good balance of electrical, mechanical and consumer appeal goals to be more readily obtained.

For instance, a relatively lower flame retardant level enables a flame retardant composition to be produced which has a very high degree of flexibility, exhibited by a low E-modulus or yield stress. This low E-modulus or yield stress may be attributable to the styrenic block copolymer or the olefinic thermoplastic elastomer and, component (A) and optionally a olefin polymer, such as PP or LLDPE in the flame retardant composition. The degree of flexibility is surprising given the presence and performance of the flame retardant system.

This in contrast to other flame retardant systems, such as melamine cyanurate, which when used in a same amount as the flame retardant system in the insulated wire according to the invention, detracts much more from the original flexural modulus of the styrenic block copolymer or olefinic thermoplastic elastomer. This negative effect would have been further augmented to a detrimental level when the amount of melamine cyanurate would have to be raised to such a level where the composition would comply with at least UL94-V2, let alone an insulated wire derived of such composition complying to UL 1581 VW-1 if possible anyway.

### Component (A)

Component (A) is a thermoplastic copolyester elastomer comprising 20 to 80 wt. % of monomeric units derived from a dimerised fatty acid or a derivative thereof and further monomeric units derived from at least one dicarboxylic acid and at least one diol, wherein wt % is given with respect to the total weight of the thermoplastic copolyester elastomer. The monomeric units derived from a dimerised fatty acid or a derivative thereof constitute a soft segment and the further monomeric units derived from at least one dicarboxylic acid and at least one diol constitute a hard segment.

Component (A) preferably is present in an amount of between 30 to 80 wt %, with respect to the total weight of flame retardant composition, more preferably between 35 to 50 wt %. If the composition according to the invention contains component (C) the amount of component (A) may be lower as compared to a composition in which component (C) is present.

Because of the presence of the monomeric units derived from a dimerised fatty acid or a derivative thereof in the thermoplastic copolyester elastomer, the thermoplastic copolyester elastomer is partially non-fossil based.

The dimerised fatty acids may be obtained from monomeric unsaturated fatty acids by an oligomerization reaction. The oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acids are saturated.

It is also possible that the thermoplastic copolyester elastomer contains monomeric units derived from derivatives of dimerised fatty acid. For example a dimerised fatty diol may be obtained as a derivative of the dimerised fatty acid by hydrogenation of the carboxylic acid groups of the dimerised fatty acid, or of an ester group made thereof. Further derivatives may be obtained by converting the carboxylic acid groups, or the ester groups made thereof, into an amide group, a nitril group, an amine group or an isocyanate group.

The dimerised fatty acids may contain from 32 up to 44 carbon atoms. Preferably the dimerised fatty acid contains 36 carbon atoms.

In the production of the thermoplastic copolyester elastomer the dimerised fatty acid can be used as a monomer or as a pre-cursor oligomer or polymer. In one example the pre-cursor polymer is a polyester, formed of dimerised fatty acid and/or dimerised fatty diol with any combination of diols or dicarboxylic acids. In another example the pre-cursor polymer is a polyamide, formed of dimerised fatty acid and/or dimerised fatty diamines with any combination of diamines or dicarboxylic acids forming polyamides. It is also possible that the pre-cursor polymer is a polyester-amide.

The dicarboxylic acid may be aliphatic or aromatic. Suitable aliphatic dicarboxylic acids include oxalic acid, succinic acid, fumaric acid, suberic acid, sebacic acid and cyclohexane dicarboxylic acid. Suitable aromatic dicarboxylic acids include terephthalic acid, isophthalic acid, ortho-phthalic acid, naphthalene-dicarboxylic acid and para-phenylene dicarboxylic acid. Preferably at least one aromatic dicarboxylic acid is terephthalic acid or naphthalene dicarboxylic acid. Preferably at least 80 mol. %, more preferably at least 90 mol. %, most preferably at least 98 mol. % of the monomeric units derived from dicarboxylic acids of the further monomer units are one or more aromatic dicarboxylic acids. The balance of the dicarboxylic acids of the further monomer units may contain of aliphatic dicarboxylic acids.

Suitable diols are aliphatic diols, for example ethylene glycol, 1,3-propylene glycol, 1,4-butanediol, 1,6-hexanediol, neopentyl glycol, trimethylene glycol, tetramethylene glycol, cyclohexane dimethanol. An example of a suitable aromatic diol is 2,2-bis (4-hydroxyphenyl) propane. Sugar based diols, like for instance isosorbide, isomannite or isoidide may also be used. Preferably greater than 50, more preferably greater than 70, particularly greater than 90, and especially greater than 95 and up to 100 moles % of the diols are aliphatic glycol (s), preferably ethylene glycol and/or 1,4-butanediol, with respect to the total amount of moles of the diol monomeric units of the thermoplastic copolyester elastomer.

In a particularly preferred embodiment of the thermoplastic copolyester elastomer, the further monomeric units are derived from 1,4-butanediol and terephthalic acid, ethylene glycol and terephthalic acid, ethylene glycol and naphthalene dicarboxylic acid, 1,4-butanediol and naphthalene dicarboxylic acid or mixtures thereof. Most preferably the further monomer units are derived from 1,4-butanediol and terephthalic acid.

The thermoplastic copolyester elastomer may further contain units of one or more polyether diols, for example poly(ethylene glycol), poly(propylene glycol), more particular poly-1,3-propylene glycol or poly-1,2-propylene glycol, poly(tetramethylene glycol), poly(hexamethyleneglycol), poly(ethylene glycol-tetramethylene glycol)copolymer, poly(ethylene glycol-propylene glycol)copolymers etc.

Preferably the thermoplastic copolyester elastomer consists of at least for 95 wt %, more preferably 98 wt % of monomeric units derived from dimerised fatty acid and/or one or more derivatives thereof, 1,4-butanediol and terephthalic acid.

Preferably the thermoplastic copolyester elastomer contains between 20 and 70 wt. % of the monomer units derived from the dimerised fatty acid and/or a derivative thereof, more preferably between 30 and 50 wt. %. This ensures a high melting point of the thermoplastic copolyester elastomer and a high flexibility and good low temperature properties.

Examples of the preparation of such thermoplastic copolyester elastomers are described in for example Handbook of Thermoplastics, etc. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996) ISBN 1-56990-205-4, in Encyclopaedia of Polymer Science and Engineering, Vol. 12, Wiley & Sons, New York (1988), ISBN 0-471-80944, p. 75-117 and the references cited therein.

The flame retardant composition may further comprise thermoplastic polymers being different from components (A) and (C), hereafter also denoted as component (G). Component (G) include for example polyester, polyamide, polycarbonate, copolyester elastomer (TPE-E), copolyamide elastomer (TPE-A), copolyurethane elastomer (TPE-U), olefinic polymer, as well as combinations thereof. Components (G) may suitably be present in amounts of between 0 to 10 wt %, with wt % being with respect to the total weight of flame retardant composition.

In applications in which high temperature stability is less critical, the presence of component (G) being a copolyurethane elastomer and/or an olefinic polymer being a polypropylene may provide a cost-effective balance between cost and functionality.

### TPE-E/TPE-A

Copolyester elastomers and copolyamide elastomers are thermoplastic polymers with elastomeric properties comprising hard blocks consisting of respectively polyester segments or polyamide segments, and soft blocks consisting of segments of another polymer. Such polymers are also known as block-copolymers. The polyester segments in the hard blocks of the copolyester elastomers are generally composed of repeating units derived from at least one alkylene diol and at least one aromatic or cycloaliphatic dicarboxylic acid. The polyamide segments in the hard blocks of the copolyamide elastomers are generally composed of repeating from at least one aromatic and/or aliphatic diamine and at least one aromatic or aliphatic dicarboxylic acid, and or an aliphatic amino-carboxylic acid.

Suitably, the further copolyester elastomer may be a copolyesterester elastomer, a copolycarbonateester elastomer, and/or a copolyetherester elastomer; i.e. a copolyester block copolymer with soft blocks consisting of segments of polyesters, polycarbonate or, respectively, polyether. Suitable copolyesterester elastomers are described, for example, in EP-0102115-B1. Suitable copolycarbonateester elastomers are described, for example, in EP-0846712-B1. Copolyester elastomers are available, for example, under the trade name Arnitel®, from DSM Engineering Plastics B.V. The Netherlands. Suitably, the copolyamide elastomer is a copolyetheramide elastomer. Copolyetheramide elastomers are available, for example, under the trade name PEBAX®, from Elf Atochem, France.

### TPE-U

A copolyurethane elastomer is a resin synthesized by the urethane reaction in which an isocyanate compound is reacted with a compound having active hydrogen, e.g., polyol, optionally in the presence of a chain-extending agent or another additive. The commercial urethane-based thermoplastic elastomers include, for example, Pellethane 2103 series (PTMG ether type), 2102 series (caproester type), 2355 series (polyester adipate type) and 2363 series (PTMG ether type) (trade names of Dow Chemical); Resamine P-1000 and P-7000 series (adipate ester type), P-2000 series (ether type), P-4000 series (caprolactone type) and P-800 series (carbonate type) (trade names of Dainichiseika Color and Chemicals); Pandex T series (trade name of DIC Covestro Polymer); Miractone E and P types (trade names of Nippon Miractone); Estolan (trade name of Takeda Burdaysh Urethane); and Morcene (trade name of Morton). They are hereinafter sometimes referred to as thermoplastic polyurethane elastomers (TPU).

### Olefinic Polymers

Olefinic polymers include, for example, a homo- or copolymer of a C₂₋₁₀ olefin such as ethylene and propylene and combinations thereof. Particularly polypropylene, LLDPE and/or ethylene-series resin (e.g., an ethylene-propylene copolymer or ethylene copolymers with propylene, butane, hexane or octene as copolymers) are preferred. The term polypropylene includes homopolymers and copolymers. The copolymers preferably contain no more than 10, 5 or 2 wt % non-propylene olefinic monomers, such as α-olefinic monomers, with wt % relative to the total amount of copolymers. The addition of olefinic polymers contributes towards a smooth surface and glossy appearance thereby increasing consumer appeal. Further, the presence of the olefinic polymer assists in improving processability of the optional component (C) being styrenic block copolymer, especially at high styrenic block copolymer levels, such as for example in amounts of at least 20 wt %, with respect to the total weight of flame retardant composition.

### Components (B), (D) and (E)

Components (B), (D) and (E) are known per se and are also referred to as flame retardant components. The component (B) in the flame retardant composition is one or more metal salts of phosphinic acids and/or diphosphinic acids or polymeric derivatives thereof, which compounds are also denoted as metal phosphinates. This term will also be used further herein to indicate the same compounds. Component (B) preferably is present in an amount of between 5 to 25 wt % with wt % being with respect to the total weight of flame retardant composition, more preferably between 10 to 20 wt %.

Suitably, the metal phosphinate is a metal of a phosphinic acid of the formula [R¹R²P(O)O]⁻ₘ M^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4.

Suitable metal phosphinates that can be used as component (B) in the present invention are described for example in DE-A 2 252 258, DE-A 2 447 727, PCT/W-097/39053 and EP-0932643-B1. Preferred phosphinates are aluminium-, calcium- and zinc-phosphinates, i.e. metal phosphinates wherein the metal M=Al, Ca, Zn respectively, and combinations thereof. Also preferred are metal phosphinates wherein R¹ and R² are the same or different and are equal to H, linear or branched C₁₋₆-alkyl groups, and/or phenyl. Particular preferably, R¹, R² are the same or different and are chosen from the group consisting of hydrogen (H), methyl, ethyl, n-propyl, iso-propyl, n-butyl, tert.-butyl, n-pentyl and phenyl. More preferably, R¹ and R² are the same or different and are chosen from the group of substituents consisting of H, methyl and ethyl.

Also preferably R³ is chosen from the group consisting of methylene, ethylene, n-propylene, iso-propylene, n-butylene, tert.-butylene, n-pentylene, n-octylene, n-dodecylene, phenylene and naphthylene.

Highly preferably, the metal phosphinate comprises a hypophosphate and/or a C₁-C₂ dialkylphosphinate, more preferably Ca— hypophosphate and/or an Al—C₁-C₂ dialkylphosphinate, i.e. Al-dimethylphosphinate, Al-methylethylphosphinate and/or Al-diethylphosphinate.

Component (D) in the flame retardant composition can be any nitrogen or nitrogen and phosphor containing compound that itself is a flame retardant and/or is a flame retardant synergist for phosphinate flame retardants. Nitrogen and phosphor containing compound is also referred to as nitrogen/phosphor containing compound. Suitable nitrogen containing and nitrogen/phosphor containing compounds that can be used as component (D) are described, for example in WO97/39053, DE-A-197 34 437, and DE-A-196 14 424. Component (D) may be present in the composition according to the invention in an amount of between 0 to 20 wt %, with respect to the total weight of flame retardant composition, more preferably between 5 to 15 wt %.

Preferably, component (D) is benzoguanamine, tris(hydroxyethyl)isocyanurate, allantoine, glycouril, melamine, melamine cyanurate, dicyandiamide, guanidine and carbodiimide, and combinations and/or derivatives thereof.

More preferably, component (D) comprises a condensations product of melamine. Condensations products of melamine are, for example, melem, melam and melon, as well as higher derivatives and mixtures thereof. Condensations products of melamine can be produced by a method as described, for example, in WO96/16948.

Preferably, component (D) is a reaction product of melamine with phosphoric acid and/or a condensation product thereof. With the reaction product of melamine with phosphoric acid and/or a condensation product thereof are herein understood compounds, which result from the reaction of melamine or a condensation products of melamine are, for example, melem, melam and melon, with a phosphoric acid. Examples include dimelaminephosphate, dimelamine pyrophosphate, melamine phosphate, melamine polyphosphate, melamine pyrophosphate, melamine polyphosphate, melam polyphosphate, melon polyphosphate and melem polyphosphate, as are described for example in WO98/39306. More preferably component (D) is melamine polyphosphate.

Also preferably, component (D) is a reaction product of ammonia with phosphoric acid or a polyphosphate modification thereof. Suitable examples include ammonium hydrogenphosphate, ammonium dihydrogenphosphate and ammonium polyphosphate. More preferably the nitrogen/phosphor containing flame retardant comprises ammonium polyphosphate.

Preferably the component (D) is a phosphate compound, more preferably a melamine phosphate compound, most preferably a melamine polyphosphate.

The flame retardant composition in the insulated wire according to the invention preferably comprises a component (E) being a basic and amphoteric oxides, hydroxides, carbonates, silicates, borates, stannates, mixed oxide-hydroxides, oxide-hydroxide-carbonates, hydroxide-silicates and hydroxide-borates, and mixtures thereof.

Component (E) may be present in the composition according to the invention in an amount of between 0 to 5 wt %, with respect to the total weight of flame retardant composition, more preferably between 0 to 4 wt %.

Preferred metal oxides are magnesium oxide, calcium oxide, aluminium oxide, zinc oxide, manganese oxide and stannum oxide.

Preferred hydroxides are aluminium hydroxide, bohmite, magnesium hydroxide, hydrotalcite, dihydrotalcite, hydrocalumite, calcium hydroxide, zinc hydroxide, stannum oxidehydrate and manganese hydroxide.

Preferably, the component (E) comprises, or even is, zinc borate, basic zinc silicate and zinc stannate, magnesium hydroxide, zinc oxide, zinc sulphide, hydrotalcite, dihydrotalcite and bohmite, and mixtures thereof, more preferably zinc borate, zinc sulphide, zinc oxide, magnesiumhydroxide, hydrotalcite and dihydrotalcite, and mixtures thereof.

Most preferably, the component (E) comprises, or even is zinc borate.

### Relative Proportions of Flame Retardant Components

In a preferred embodiment of the invention, the flame retardant composition comprises the components (B), (D) and optionally (E) in a total weight of 10-50 wt. %, more preferably 15-40 wt. %, more preferably 18-35 wt. % and even 20-30 wt. %, relative to the total weight of the flame retardant composition.

More preferably, the components (B), (D) and (E) are present in an amount of respectively, 20-90 wt. %, or even 50-80 wt. % of component B, 10-80 wt. % or even 20-50 wt. % of component (D), and 0-20 wt. %, or even 2-10 wt. % of component (E), relative to the total weight of the components (B), (D) and (E).

In a more preferred embodiment in the flame retardant composition according to the invention, the metal salt (B) and the flame retardant component (E) are present in a weight ratio in the range of 9:1-2:9, preferably 5:1-1:1.

In another more preferred embodiment, component (E) is present in an amount of 0.01-5 wt. %, preferably 0.1-2 wt. %, relative to the total weight of the flame retardant composition.

### Component (C)

Styrenic Block Copolymers and/or an Olefinic Thermoplastic Elastomers (TPO)

The flame retardant composition optionally comprises component (C) being a styrenic block copolymer and/or an olefinic thermoplastic elastomer.

Preferably, component (C) is present in the flame retardant composition in at least 10 wt %, 12 wt % 15 wt %, 18 wt %, 20 wt %, 25 wt %, 30 wt % or 40 wt % relative to the total weight of the flame retardant composition. The higher the proportion of component (C), the greater the consumer appeal properties as measured by softness and flexibility. Component (C) preferably is present in the flame retardant composition in an amount of at most 40 wt %, preferably at most 35 wt % relative to the total weight of the flame retardant composition. In general, too high a level of component (C) results in a decreased flame retardancy and a deterioration in some mechanical properties.

The styrenic block copolymer includes diblock or triblock polymers or combinations thereof. Styrenic block copolymers have good surface quality, high dimensional stability and constant mechanical properties almost up to the softening temperature. Presence of component (C) has the advantage that the composition may be become softer and may exhibit a higher consumer appeal.

Preferred styrenic block copolymers include an acrylonitrile-styrene copolymer (AS), an acrylonitrile-butadiene-styrene copolymer (ABS), a styrene-butadiene-styrene (SBS) copolymer, a styrene-isoprene-styrene (SIS) copolymer, a styrene-ethylene-butylene-styrene (SEBS) copolymer, a styrene-acrylonitrile-ethylene-propylene-ethylidene norbornene copolymer (AES), and a hydrogenated product thereof. Hydrogenated block copolymers include an ethylene/butylene in the midblock (S-(EB/S)-S) and polystyrene-b-poly(ethylene/propylene), polystyrene-b-poly(ethylene/propylene)-b-polystyrene, polystyrene-b-poly(ethylene/butylene)-b-polystyrene and polystyrene-b-poly(ethylene-ethylene/propylene)-b-polystyrene.

Preferably, the styrenic block copolymer is a hydrogenated styrenic block copolymer as this class of compound exhibits excellent UV resistant properties.

Particularly preferred styrenic block copolymers includes, a styrene-ethylene-butylene-styrene (SEBS) copolymer or a styrene-ethylene/propylene-styrene (SEPS). The styrenic block copolymers may be used alone or in combination.

The styrenic block copolymers are preferably grafted with maleic anhydride (MA) or the like onto the copolymer midblock. Typically, between 0.5 to 5.0 wt. % MA, more preferably, 1.0 to 2.5 wt % relative to the total weight of the styrenic block copolymer is grafted onto the block copolymer. The MA grafting improves the adhesion of the copolymer to a variety of substrates including polyamides and polyester.

The styrenic block copolymers preferably have a styrene content, relative to the total weight of the styrenic block copolymer, of at least 10 wt. %, more preferably at least 20 wt. %, more preferably at least 30 wt. %, even more preferably at least 35 wt. % and most preferably at least 40 wt. %. It has been found that the higher the styrenic content the less flame retardant components (B), (D) and (E) is required to achieve the same level for flame retardancy. The styrene content, relative to the total weight of the styrenic block copolymer, is preferably no more than 70 wt. % and more preferably no more than 60 wt. %. Too high a styrene content tends to result in stiffer compositions which are not suitable for cable and wire applications.

The styrene content is determined according to the method outlined in ISO 5478:2006.

Preferable the styrenic block copolymer has a MFI of at least 10 g/10 min (230° C./2.16 kg), and more preferably 10 g/10 min (230° C./2.16 kg). A higher MFI contributes to a smoother surface of the resultant cables.

Olefinic thermoplastic elastomers, within the scope of the present invention, include thermoplastic olefins (uncrosslinked thermoplastic elastomers) and thermoplastic vulcanizates (crossed linked thermoplastic elastomers). TPOs impart rubber-like properties, such as softness and flexibility, which translate into an increase consumer appeal in the resultant insulated wires. TPOs may also provide cost benefits in applications in which heat resistance, flame retardancy requirements are low.

TPOs are polyolefinic matrices, preferably crystalline, through which thermoplastic or thermoset elastomers are generally uniformly distributed. Examples of TPOs include EPM and EPDM thermoset materials distributed in a crystalline polypropylene matrix. Any conventional TPO having the desired softness, flexibility and strength may be used in the present invention. Although not intended to be limiting, examples of suitable TPOs for use in the present invention include those prepared by blending an olefinic thermoplastic and either an ethylene copolymer or terpolymer, such as disclosed in U.S. Pat. No. 4,990,566 to Hert, or a nitrile rubber, such as disclosed in U.S. Pat. No. 4,591,615 to Aldred et al, the disclosure of both of which are incorporated herein by reference.

Commercial TPOs, also called TPV, are typically based on vulcanized rubbers in which a phenolic resin, sulfur or peroxide cure system is used to vulcanize, that is crosslink, a diene (or more generally, a polyene) copolymer rubber by way of dynamic vulcanization, which is a process in which the rubber is crosslinked while mixing (typically vigorously), in a thermoplastic matrix therefore enabling further thermal processing and/or recycleability of the material. Although any cure system is contemplated by the present embodiments, sulfur is typically preferred over peroxide free radical or a phenolic resin cure systems because peroxide may degrade and/or crosslink the polypropylene or polyethylene thermoplastic as well as the rubber. This is in turn limits the extent of rubber crosslinking that can occur before the entire mixture degrades or crosslinks and is no longer thermoplastic, while phenolic cure systems may cause a yellowish tint to the final product.

Two examples of preferred commercial TPOs are SANTOPRENE®. thermoplastic rubber, which is manufactured by Exxon Mobil Chemical and SARLINK®, available from Teknor Apex, both of which are a mixture of crosslinked EPDM particles in a crystalline polypropylene matrix.

A typical TPO is a melt blend or reactor blend of a polyolefin plastic, typically a propylene polymer, with a crosslinked olefin copolymer elastomer (OCE), typically an ethylene-propylene rubber (EPM) or an ethylene-propylene-diene rubber (EPDM). In those TPO's made from EPDM, the diene monomer utilized in forming the EPDM terpolymer is preferably a non-conjugated diene. Illustrative examples of non-conjugated dienes which may be employed are dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene and the like.

### Component (F)

The flame retardant composition in the insulated wires according to the invention may suitably comprise one or more additives, also denoted as component (F). The additive or additives that can be used in the flame retardant composition may be any auxiliary additive, or combination of auxiliary additives, that is suitable for use in flame retardant compositions.

Suitable additives include stabilizers, such as antioxidants, UV-absorbers and heat stabilizers, toughners, impact modifiers, plasticizers, lubricants, emulsifiers, nucleating agents, fillers, pigments, optical brighteners, further flame retardants, and antistatic agents. Suitable fillers are, for example, calcium carbonate, silicates, talcum, and carbon black.

Preferably, the flame retardant composition comprises one or more stabilizers. Suitable compounds that can be used as stabilizer include phosphites and phosphonites, esters and salts of long chain fatty acids and dicarboxamide compounds.

In a preferred embodiment of the invention the flame retardant composition comprises one or more additives in a total weight of 0.01 to 20 wt. %, more preferably 0.1 to 10 wt. %, still more preferably 0.2 to 5 wt. %, or even 0.5 to 2 wt. % relative to the total weight of the flame retardant composition.

More preferably, the flame retardant composition comprises one or more compounds chosen from the group of phosphites and phosphonites, esters and salts of long chain fatty acids and dicarboxamide compounds, in a total weight of the one or more compounds of 0.01-3 wt. %, still more preferably 0.1-1.0 wt. %, relative to the total weight of the flame retardant composition.

In a another preferred embodiment, the flame retardant composition comprises a lubricant in the total weight of 0.1-10 wt. %, relative to the total weight of the flame retardant composition and more preferably 0.2-5 wt. %, or even 0.5-2 wt. %. Suitable lubricants include hydrocarbon oils (eg. mineral, paraffin based oils) and/or silicone oils in addition to silicone compounds. Higher levels of lubricants, particularly hydrocarbon based lubricants lead to a decrease in the composition's flame retardancy. Suitable silicone compounds include silicone gums, silicone resins and/or silicone greases.

Suitable silicone compounds, include polysiloxane compounds such as polydimethylsiloxane. Preferably the lubricant is an ultra-high molecular weight (i.e solid 25° C.) polydimethylsiloxane such as products in the GENIOPLAST® resin range available from Wacker. The increased molecular weight compared to silicon oils reduces the prevalence of blooming of the silicone compounds, which have a detrimental effect on the surface's printing properties. Other suitable silicone compounds are also described in WO/2008/030768.

The invention thus also relates to a flame retardant composition, wherein the flame retardant composition consists essentially of, expressed as wt % relative to the total weight of the flame retardant composition unless denoted otherwise:
Component (A) in an amount of between 30 wt % to 80 wt % of a thermoplastic copolyester elastomer, comprising 20 to 80 wt. %, wherein wt % of monomeric units is with respect to the total weight of the thermoplastic copolyester elastomer, of monomeric units derived from a dimerised fatty acid or a derivative thereof and further monomeric units derived of at least one dicarboxylic acid and at least one diol;
Component (B) in an amount of between 5 wt % to 25 wt % of a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙM^{m+} (formula II), and/or a polymer thereof, wherein
   R¹ and R² are equal or different substituents chosen from the group consisting of hydrogen, linear, branched and cyclic C1-C6 aliphatic groups, and aromatic groups,
   R³ is chosen from the group consisting of linear, branched and cyclic C1-C10 aliphatic groups and C6-C10 aromatic and aliphatic-aromatic groups,
   M is a metal chosen from the group consisting of Mg, Ca, Al, Sb, Sn, Ge, Ti, Zn, Fe, Zr, Ce, Bi, Sr, Mn, Li, Na, and K, and
   m, n and x are equal or different integers in the range of 1-4; and optionally
Component (C) in an amount of between 0 wt % to 40 wt % of styrenic block copolymer and/or an olefinic thermoplastic elastomer; and
Component (D) in an amount of between 0 wt. % to 20 wt % of a nitrogen containing flame retardant synergist and/or a phosphor/nitrogen containing flame retardant; and
Component (E) in an amount of between 0 wt. % to 5 wt. % of basic and amphoteric oxides, hydroxides, carbonates, silicates, borates, stannates, mixed oxide-hydroxides, oxide-hydroxide-carbonates, hydroxide-silicates and hydroxide-borates, and mixtures thereof; and
Component (F) being further additives in an amount of between 0 wt % to 10 wt %; and
Component (G) being a thermoplastic polymer different from components (A) and (C), and being a copolyester elastomer, a copolyamide elastomer, a copolyurethane elastomer, polyolefin and combinations thereof, in an amount of between 0 wt % to 10 wt %;

wherein the total weight of all components adds up to 100%.

### SPECIAL EMBODIMENTS

The combination of component (A), and flame retardants (B) and optionally component (C), (D), (E) provide a unique combination of flame retardant properties, mechanical and electrical properties all achieved while providing an insulated cable with enhanced consumer appeal as indicated by softness, surface feel and appearance, flexibility and density. In addition, the effectiveness of both the flame retardant component (B) and (D) to impart flame retardant properties and the styrenic block copolymer and/or olefinic thermoplastic elastomers component (C) to impart consumer properties, enables the flexibility of additional components to be added to improve the other functionalities such as processability, thermal resistance, mechanical strength, and surface appearance and feel.

A higher minimal total weight for components (B), and optionally (D) and/or (E) has the advantage that even better flame retardancy properties are obtained. A lower maximum total weight for components (B) optionally (D) and/or (E) has the advantage that the insulated wires have an improved softness and flexibility. Further, the relatively low levels of flame retardants required under the scope of the present invention enables a greater flexibility to tailor specific formulations to specific need use applications while maintaining the required flame retardant, mechanical, electrical, heat resistant and consumer appeal properties.

For instance, as another embodiment of the present invention there is provided an insulated wire for use in electronic equipment, comprising an electrically conductive core and an insulating layer and/or an insulating jacket comprising or even consisting of a flame retardant composition surrounding the electrically conductive core, wherein the flame retardant composition the formulation (%. wt expressed relative to the total weight of the flame retardant composition) essentially consists of:

30 wt % to 80 wt % component (A), preferably 35 to 50 wt %;

5 wt % to 25 wt % component (B), preferably 10 to 20 wt %;

0 wt % to 40 wt % component (C), preferably 20 to 35 wt %;

0 wt % to 20 wt % component (D), preferably 5 to 15 wt %;

0 wt. % to 5 wt. % component (E); preferably 0 to 4 wt %;

0 wt. % to 10 wt % component (F);

0 wt % to 10 wt % component (G).

The components refer to the description above, including all preferred embodiments.

The combined level of the flame retardant components (B) and (D) is preferably between 20 wt % and 40 wt. % and more preferably between 25 wt % and 35 wt. % relative to the total weight of the flame retardant composition.

Preferably, component (C) is in the range of 20 wt. % to 40 wt. % and more preferably 20 wt. % to 35 wt. % relative to the total weight of the flame retardant composition.

This composition is able to comply with the UL 1581 VW-1 standard, especially when the proportion of flame retardants (B) and (D) are at the upper range limit (i.e 25 wt. % to 35 wt. % (B) and (D) combined), while lower flame retardant standards are maintainable at lower levels of component (B) and optionally (D) and/or (E). The relatively lower levels of the flame retardant system (B), (D) and (E) result in a relatively lighter (lower density) cable, compared to other non-halogen flame retardant systems, which has the mechanical and consumer appeal properties associated with the styrenic block copolymer and optionally the olefins.

If component (C) is a TPO, the combined level of flame retardant components (B) and (D) is preferably increased to between 20 wt % to 40 wt %.

Preferably, the insulation resistance in water is greater than 0.5, 0.75, 1.0, 1.5 or 2.0 GΩm.

Preferably, the elongation at break, determined according to ISO 527/1A, of the flame retardant composition is at least 200%, 300%, 400%, 500% or even at least 600%.

Preferably, the E-modulus, determined according to ISO 527/1A, of the flame retardant composition is less than 150, 100 MPa, 90 MPa, 80 MPa, 70 MPa 60 MPa, 50 MPa or 40 MPa. Preferably, the composition has a minimum E-Modulus of at least 5 MPa and more preferably at least 10 MPa, to enable the cable to have sufficient rigidity to perform its function.

Preferably, the yield stress, determined according to ISO 527/1A, is less than 12 MPa, more preferably less than 6 MPa, more preferably less than 5 MPa and even more preferably less than 4 MPa. Preferably, the composition has a minimum yield stress of at greater 1.2 MPa and more preferably at greater 1.8 MPa, to enable the cable to have sufficient rigidity to perform its function.

Preferably the Shore A hardness, determined according to DIN 53505, is less than 95, 90, 85, 80, 70, 60, 50 or 40.

Preferably the Shore D hardness, determined according to ISO R 868, is less than 50, 45, 40, 36, 34, 33, 32 or 31.

Preferably, the roughness (Ra) of the cable surface is less than 11 Ra, more preferably less than 8 Ra, more preferably less than 6 Ra, more preferably less than 5 Ra, more preferably less than 4 Ra, even more preferably less than 3 Ra and most preferably less than 2 Ra.

The combination of elasticity (% elongation at break), softness (low Shore A hardness), flexibility (low E modulus and yield stress) and/or smoothness (low roughness Ra) are mechanical properties of particular importance to the consumer appeal of the resultant insulated wire or product derived therefrom.

The invention in particular relates to an insulated wire wherein the insulated wire is a bipolar or tripolar wire consisting of two or three electrically conductive cores, two or three insulating layers each surrounding one of the electrically conductive cores, and optionally a jacket layer surrounding the electrically conductive cores and the insulating layers, wherein the insulating layers and/or the jacket layer consist of the flame retardant composition comprising components (A) (B) and optionally (C), (B) and (C) or any preferred embodiment thereof as described above.

The invention also relates to a connection cable comprising (i) a piece of an insulated wire according to the invention or any preferred embodiment thereof and (ii) one or two connection elements, for connecting the cable to electrical and/or electronic equipment and/or to a power supply unit, fixed to the piece of insulated wire and optionally (iii) a electrical or electronic part.

Suitably, the connection cable is a mobile phone charger cable or computer accessory connection cable.

The invention further relates to the use of the inventive insulated wires and connection cables made thereof in or connected to electronic equipment and to electronic equipment comprising insulated wires according to the invention, or any preferred embodiment thereof.

The invention also relates to a flame retardant composition. The flame retardant composition according to the invention corresponds with the flame retardant composition in the insulated wire according to the invention described here above, and any of the preferred embodiments thereof. The advantage of the flame retardant composition according to the invention resides in the combined effects on flame retardancy and consumer appeal properties, in addition to other effects when the flame retardant composition is applied in electrical cables as described above.

The flame retardant composition can be made by compounding methods used in the art for making flame retardant compositions in general and elastomeric thermoplastic compositions in particular. Suitable methods include methods involving melt mixing, i.e. methods wherein component (A) and optionally component (C) are transformed into a melt and the components (B) and other optional components are added, simultaneously, consecutively or partly simultaneously and partly consecutively to the component (A) and optionally component (C) prior, during or after the transformation into the melt and the polymer melt and other components and additives are mixed to form a homogenous mixture.

Suitably, this melt mixing is performed in an extruder and the homogenous mixture after being formed by said melt mixing is discharged from the extruder after which the composition is cooled and optionally granulated.

It is also possible to add the flame retardant components and the additives in the form of a master batch. It is also possible, in particular with solid additives, to add the additive or additives after cooling and optional granulation, whereby the additive or additives is applied on the granule surface.

The cooled and optionally granulated composition can be used for making the insulated wires, for example by extrusion coating of one or more metal wires which than form the electrically conductive core of the resulting insulated wires.

The invention is further illustrated with the following Examples and Comparative Experiments.

### Examples

### Materials

Component (A): Thermoplastic copolyester elastomer comprising 50 wt % monomeric units derived from a dimerised fatty acid and further monomeric units derived of terephthalic acid and 1,4-butanediol, wherein wt % is with respect to the total weight of the thermoplastic copolyester elastomer. Shore-D hardness is 34.
Component (B): Exolit OP1230: Aluminium diethylphosphinate; Clariant, Germany.
Component (C): Styrenic block copolymer available from Kraton under the trade name Kraton SEBS1536 HS.
TPE-E: Polyetherester elastomer (TPE-E) comprising hard segments consisting of polybutyleneterephthalate segments and soft segments consisting of poly(tetramethylene glycol). Shore-D hardness is 33.
Component (D): Melapur® 200 (MPP): Melamine polyphosphate; Ciba Geigy, Switzerland.
Component (E): Zinc Borate (2 ZnO₃B₂O₃.3.5H₂O), Firebrake® 500, Borax, USA
Add F1: Blend of auxiliary stabilizer package.
Add F2: Silicon gum comprising ultrahigh-molecular-weight polydimethylsiloxane in pellet form available from Wacker under the trade name Genioplast® Pellet S.

### Compounding

For the preparations of moulding compositions, ingredients were compounded in ratios as indicated in Tables 1 to 3. The moulding compositions were prepared by melt-blending the components A and optionally C with the flame retardant components and stabilizer package on a ZSK 25/33 screw speed 400 rpm respectively, throughput of 25 kg/hr, and melt temperature regulated at <260° C., extruding the melt from the extruder through a die, and cooling and granulating the melt. The granules obtained by compounding in the extruder were dried for 24 hours at 90° C., prior to further use.

### Moulding of Test Samples and Insulated Cables

Test samples for testing the mechanical properties and the flame retardancy properties according to UL-94-V (1.5 mm thickness) were prepared on an injection-moulding machine of type Engel 80 A. For the injection moulding set temperatures of 200-230° C. were used.

Insulated cables for testing the flame retardancy properties according to UL 1581 VW-1 were prepared on an industrial production line under comparable operating conditions at a speed of between 50 to 100 m/min. The cables thus produced included:
Cable 1: Insulated 18AWG cable. This cable is used in NC power cable type applications.
Cable 2: Insulated jacketed SVE cable containing 3 cores of Insulated 18AWG cable. This cable is used for NC power cable type applications.

### Test Methods

### Mechanical Properties:

Tensile tests (E-modulus, Stress at yield and elongation at break) were performed according to ISO 527/1A using dry-as-moulded samples. Dimensions of tensile test specimens: thickness 4 mm.
Shore A hardness, according to DIN 53505

### Flame Retardancy

Sample preparation and testing was performed according to UL1581 VW-1. Three individual samples were measured for each cable sample and the after contact burn time for each of the five flame contacts was recorded. The sum of the 5 burn times was defined as the total burn time of an individual sample. The average total burn time of all three individual samples was determined for each cable sample and used to compare the flame retardancy performance across different cables samples in a quantitative manner.

Compositions according to the invention, Examples 1 to 5 (E1-E5) and Comparative Experiments A and B (CEA, CE-B) were prepared and tested as described above. The compositions and test results are presented in Table 1.

TABLE 1
Compositions and results for Examples 1-5 and Comparative Experiments A and B

| | | | | | | |
|---|---|---|---|---|---|---|
| CE-A | Example 1 | Example 2 | CE-B | Example 3 | Example 4 | Example 5 |

Compositions (wt %)

| | | | | | | | |
|---|---|---|---|---|---|---|---|
| Component (A) | | 46.0 | 48.1 | | 38.5 | 43.0 | 74.0 |
| TPE-E | 46.0 | | | 38.5 | | | |
| Component (B) | 14.2 | 14.2 | 13.3 | 19.0 | 19.0 | 17.0 | 14.2 |
| Component (C) | 25.0 | 25.0 | 25.0 | 30.0 | 30.0 | 30.0 | |
| Component (D) | 7.1 | 7.1 | 6.7 | 9.5 | 9.5 | 8.5 | 7.1 |
| Component (E) | 0.8 | 0.8 | | 1.5 | 1.5 | 0.0 | 0.8 |
| Add F1 | 5.4 | 5.4 | 5.4 | 1.6 | 1.6 | 1.6 | 2.4 |
| Add F2 | 1.5 | 1.5 | 1.5 | | | | 1.5 |
| Total | 100 | 100 | 100.0 | 100.0 | 100.0 | 100.0 | 100.0 |

Mechanical Results

| | | | | | | | |
|---|---|---|---|---|---|---|---|
| Tensile strength (MPa) | 9.4 | 9.2 | 8.3 | 11.1 | 7.7 | 7.4 | 8.7 |
| E-modulus (MPa) | 49 | 54 | 52 | 53 | 78 | 56 | 83 |
| Elongation at break (%) | 410 | 381 | 324 | 433 | 256 | 307 | 318 |
| shore-A hardness | 89 | 91 | 91 | 90 | 92 | 91 | 95 |

Mechanical retentions after heat aging (121° C., 168 hrs)

| | | | | | | | |
|---|---|---|---|---|---|---|---|
| Tensile strength (% ret.) | 104 | 112 | 110 | 113 | 114 | 112 | 97 |
| Elongation at break (% ret.) | 93 | 112 | 108 | 105 | 113 | 110 | 75 |

Cable results

| | | | | | | | |
|---|---|---|---|---|---|---|---|
| Cable type | Cable 2 | Cable 2 | Cable 2 | Cable 1 | Cable 1 | Cable 1 | Cable 2 |
| Av. Total burn time VW-1 (s) | 55 | 30 | 28 | 14 | 13 | 15 | 23 |

### Results

The results summarized in Table 1 show that all compositions yield insulated wires with a sufficient consumer appeal while maintaining a sufficient combination of flame retardant and mechanical properties to satisfy UL62 norm requirements. Surprisingly, however, when comparing Example 1 with CE-A and

Example 3 with CE-B, it is clear that the compositions comprising Component (A) give rise to much improved flame retardancy properties. In addition, heat aging properties of the compositions according to the invention are excellent (mechanical retentions >100%. Even more surprisingly, Example 2 and 4 illustrate that compositions according to the invention allow significantly lower amounts of flame retarding components (B), (D) and (E), while maintaining the flame retardancy properties at approximately the same, improved level. This leads to better processability, higher overall consumer appeal and lower ecological footprint of the compositions and the ensuing insulating wires. Example 5 does not contain component (C), which has the advantage that the composition exhibits the highest level of biorenewable content, while still exhibiting sufficient flame retardant properties.

1. Flame retardant composition comprising
Component (A) being a thermoplastic copolyester elastomer comprising 20 to 80 wt. % of monomeric units derived from a dimerised fatty acid or a derivative thereof and further monomeric units derived from at least one dicarboxylic acid and at least one diol, wherein wt % is with respect to the total weight of the thermoplastic copolyester elastomer; and
Component (B) being a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4.

2. Flame retardant composition according to claim 1, further comprising component (C) being a styrenic block copolymer and/or an olefinic thermoplastic elastomer.

3. Flame retardant composition according to claim 2, wherein component (C) is present in at least 15 wt % relative to the total weight of the flame retardant composition.

4. Flame retardant composition according to claim 1, further comprising a component (G), being a thermoplastic polymer different from component (A) and (C), component (G) being a polyester, polyamide, polycarbonate, copolyester elastomer (TPE-E), copolyamide elastomer (TPE-A), copolyurethane elastomer (TPE-U), olefinic polymer, as well as combinations thereof.

5. Flame retardant composition according to claim 1, further comprising component (D) being a nitrogen containing flame retardant synergist and/or a phosphor/nitrogen containing flame retardant.

6. Flame retardant composition according to claim 1, further comprising component (E) being a basic and amphoteric oxides, hydroxides, carbonates, silicates, borates, stannates, mixed oxide-hydroxides, oxide-hydroxide-carbonates, hydroxide-silicates and hydroxide-borates, and mixtures thereof.

7. Flame retardant composition according to claim 1 wherein the amounts are as follows with wt % relative to the total weight of flame retardant composition;
30 wt % to 80 wt % component (A);
5 wt % to 25 wt % component (B);
0 wt % to 40 wt % component (C);
0 wt % to 20 wt % component (D);
0 wt. % to 5 wt. % component (E);
0 wt. % to 10 wt % component (F);
0 wt % to 10 wt % component (G).

8. Flame retardant composition according to claim 1, wherein the flame retardant composition consists essentially of, expressed as wt % relative to the total weight of the flame retardant composition unless denoted otherwise:
Component (A) in an amount of between 30 wt % to 80 wt % of a thermoplastic copolyester elastomer, comprising 20 to 80 wt. %, wherein wt % of monomeric units is with respect to the total weight of the thermoplastic copolyester elastomer, of monomeric units derived from a dimerised fatty acid or a derivative thereof and further monomeric units derived of at least one dicarboxylic acid and at least one diol;
Component (B) in an amount of between 5 wt % to 25 wt % of a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4; and optionally
Component (C) in an amount of between 0 wt % to 40 wt % of styrenic block copolymer and/or an olefinic thermoplastic elastomer; and
Component (D) in an amount of between 0 wt. % to 20 wt % of a nitrogen containing flame retardant synergist and/or a phosphor/nitrogen containing flame retardant; and
Component (E) in an amount of between 0 wt. % to 5 wt. % of basic and amphoteric oxides, hydroxides, carbonates, silicates, borates, stannates, mixed oxide-hydroxides, oxide-hydroxide-carbonates, hydroxide-silicates and hydroxide-borates, and mixtures thereof; and
Component (F) being further additives in an amount of between 0 wt % to 10 wt %; and
Component (G) being a thermoplastic polymer different from components (A) and (C), and being a copolyester elastomer, a copolyamide elastomer, a copolyurethane elastomer, polyolefin and combinations thereof, in an amount of between 0 wt % to 10 wt %;
wherein the total weight of all components add up to 100%.

9. Flame retardant composition according to claim 1, wherein the flame retardant composition consists essentially of, expressed as wt % relative to the total weight of the flame retardant composition unless denoted otherwise:
Component (A) 35 wt % to 50 wt % being a thermoplastic copolyester elastomer comprising 20 to 80 wt. %, wherein wt % of monomeric units is with respect to the total weight of the thermoplastic copolyester elastomer, of monomeric units derived from a dimerised fatty acid or a derivative thereof and further monomeric units derived of at least one dicarboxylic acid and at least one diol; and
Component (B) 10 wt % to 20 wt % being a metal salt of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4, and
Component (C) 20 wt % to 35 wt % being a styrenic block copolymer and/or an olefinic thermoplastic elastomer; and
Component (D) 5 wt. % to 15 wt. % being a nitrogen containing flame retardant synergist and/or a phosphor/nitrogen containing flame retardant.
Component (E) 0 wt. % to 5 wt. % of basic and amphoteric oxides, hydroxides, carbonates, silicates, borates, stannates, mixed oxide-hydroxides, oxide-hydroxide-carbonates, hydroxide-silicates and hydroxide-borates, and mixtures thereof; and
Component (F) 0 wt % to 10 wt % being additives; and
Component (G) 0 wt % to 10 wt % being a thermoplastic polymer different from components (A) and (C), and being a copolyester elastomer, a copolyamide elastomer, a copolyurethane elastomer, polyolefin and combinations thereof;
wherein the total weights of all components add up to 100%.

10. Flame retardant composition according to claim 1, wherein component (B) and the component (D) are present in a weight ratio in the range of 9:1-2:9.

11. An insulated wire for use in electronic equipment, comprising an electrically conductive core and an insulating layer and/or an insulating jacket comprising or consisting of a flame retardant composition surrounding the electrically conductive core, wherein the flame retardant composition is the flame retardant composition according to claim 1.

12. The insulated wire according to claim 11, wherein the insulated wire is a bipolar or tripolar wire consisting of two or three electrically conductive cores, two or three insulating layers each surrounding one of the electrically conductive cores, and optionally a jacket layer surrounding the electrically conductive cores and the insulating layers, wherein the insulating layers and/or the jacket layer consist of the flame retardant composition.

13. A connection cable comprising (i) a piece of an insulated wire according to claim 11 and (ii) one or two connection elements, for connecting the cable to electrical and/or electronic equipment and/or to a power supply unit, fixed to the piece of insulated wire and optionally (iii) an electrical or electronic part.

14. The connection cable of claim 13, wherein the connection cable is a mobile phone charger cable or computer accessory connection cable.
